(19) United States
(12) Patent Application Publication
(10) Pub. No.: US 2026/0329352 A1
(43) Pub. Date: Oct. 22, 2026

(54) Docking Station Articulation

(71) Applicant: Google LLC, Mountain View, CA (US)

(72) Inventors: Varn Khanna, Vallejo, CA (US); Chintan Trehan, San Jose, CA (US); Phillip Satterfield, Oakland, CA (US); Ruth Rosalind Lewis, San Francisco, CA (US)

(73) Assignee: Google LLC, Mountain View, CA (US)

(21) Appl. No.: 18/993,484

(22) PCT Filed: Nov. 1, 2023
(86) PCT No.: PCT/US2023/078351

§ 371 Date: Jan. 10, 2025

(51) Int. Cl. G06F 1/16; H01F 7/06

(52) U.S. Cl. CPC G06F 1/1681; H01F 7/064

(57) ABSTRACT

Techniques and apparatuses are described that implement docking station (dock) articulation, including a method of controlling an articulation of a dock that includes determining a hinge torque setting, applying the hinge torque setting to a hinge assembly of the dock to support the angular position of the device relative to the dock, receiving position sensor data from a position sensor, utilizing the position sensor data to determine a user-induced motion to change the angular position of the device to a new angular position, changing the hinge torque setting to permit the change in the angular position of the device to the new angular position, receiving updated position sensor data from the position sensor, utilizing the updated position sensor data to determine a cessation of the user induced motion, and changing the hinge torque setting to support the new angular position of the device relative to the dock.

### BACKGROUND

A mobile computing device (e.g., a tablet computer) may be configured for use with a docking station (“dock”). A user can place such a mobile device in a dock to power a battery of the device, to support the mobile device relative to a surface (e.g., a countertop), and/or to supplement the functionality of the device. For example, a dock may wirelessly connect with the mobile device and/or may include a data terminal that engages a data terminal of the mobile device. The mobile device may communicate data to the dock, for example, to play music. The dock may include components that are superior to components in the mobile device, for example, speakers that are larger than those of the mobile device. In some aspects, a dock may include a hinged portion (e.g., a hinge assembly) that enables a screen of the mobile device to be articulated to improve the viewing angle of a display of the mobile device.

Hundreds of different designs for tablet computers exist, with new designs released each year. It is common for one model of a tablet computer to have a different form factor, size, and/or weight than another model. These variations can make it a challenge to manufacture a “universal” docking station that functions well for multiple tablet computer models. For example, to support the weight of a heavy tablet computer model, the hinge assembly of an articulated docking station may need a high torque setting that would feel stiff and unresponsive when utilized with a lighter tablet computer model. In another example, to provide a secure connection to a tablet computer on a mounting portion of a dock, the mounting portion may include one or more magnets. A larger tablet computer model, compared to a smaller tablet computer, may require the utilization of a stronger magnetic force to connect the tablet computer to the mounting portion. The use of stronger magnets may make a lighter tablet computer harder to remove from the dock. In contrast, the use of weaker magnets may make a heavier tablet computer more prone to accidentally unmount.

### SUMMARY

This document describes techniques and apparatuses directed at docking station articulation. In aspects, the techniques and apparatuses are implemented on articulated docking stations for mobile computing devices (e.g., an articulated docking station utilizing adaptive hinge torque).

In some aspects, the techniques described herein relate to a method for controlling an articulation of a docking station, the method including: determining a mounting of a mobile computing device to the docking station; determining a hinge torque setting for supporting an angular position of the mobile computing device relative to the docking station; applying the hinge torque setting to a hinge assembly of the docking station to support the angular position of the mobile computing device relative to the docking station; receiving position sensor data from a position sensor; determining, utilizing the position sensor data, a user-induced motion to change the angular position of the mobile computing device to a new angular position; changing the hinge torque setting to permit the change in the angular position of the mobile computing device to the new angular position; receiving updated position sensor data from the position sensor; determining, utilizing the updated position sensor data, a cessation of the user-induced motion; and changing the hinge torque setting to support the new angular position of the mobile computing device relative to the docking station.

In some aspects, the techniques described herein relate to a method, wherein determining the hinge torque setting for supporting the angular position of the mobile computing device relative to the docking station further includes: determining a hinge torque profile for the mounted mobile computing device, the hinge torque profile including a nominal current value for applying to a magneto-rheological (MR) brake of the docking station to generate a magnetic field that maintains an angular position of the mounted device relative to the docking station.

In some aspects, the techniques described herein relate to a method, wherein changing, responsive to determining the user-induced motion, the hinge torque setting to permit the change in the angular position of the mounted mobile computing device includes: decreasing a current value applied to the MR brake to a level below the nominal current value to decrease a damping force of the MR brake.

In some aspects, the techniques described herein relate to a method, wherein changing the hinge torque setting to support the new angular position of the mobile computing device relative to the docking station further includes: increasing the current value applied to the MR brake at an increased level above the decreased current value to increase the damping force of the MR brake and maintain the new angular position of the mounted device.

In some aspects, the techniques described herein relate to a method, further including: determining a direction of the user-induced motion of the hinge assembly to change the angular position of the mounted device, and wherein decreasing the current value applied to the MR brake to a level below the nominal current value to decrease the damping force of the MR brake is performed for user-induced motion in the determined direction.

In some aspects, the techniques described herein relate to a method, wherein determining a hinge torque profile for the mobile computing device includes at least one of: receiving a device identifier from the mobile computing device and looking up the device identifier in a lookup table to determine the hinge torque profile; determining a device identifier for the mobile computing device and looking up the device identifier in a lookup table to determine the hinge torque profile; receiving the hinge torque profile from the mobile computing device; receiving user input and determining the hinge torque profile based on the user input; or applying a default hinge torque profile.

In some aspects, the techniques described herein relate to a method, further including: determining an unmounting of the mobile computing device from the docking station; and responsive to determining the unmounting, decreasing the current value applied to the MR brake to a level below the nominal current value to decrease the damping force of the MR brake.

In some aspects, the techniques described herein relate to a method, wherein determining the mounting of the mobile computing device to the docking station further includes at least one of: utilizing a sensor to determine a presence of the mobile computing device at the docking station; determining that the mobile computing device has physically connected with the docking station; determining that the mobile computing device has wirelessly connected with the docking station; or receiving a wireless communication from the mobile computing device.

In some aspects, the techniques described herein relate to a method, further including: storing the determined hinge torque profile for the mobile computing device.

In some aspects, the techniques described herein relate to a method, further including: determining, utilizing the position sensor, a used angular position of the mounted device; storing the used angular position; and momentarily increasing the current value applied to the MR brake when the user-induced motion reaches the used angular position to provide feedback to a user of the stored used angular position.

In some aspects, the techniques described herein relate to a method, further including: receiving user input to lock the angular position of the mounted device; and responsive to receiving the user input to lock the angular position of the mounted device, increasing the current value applied to the MR brake to lock the angular position of the mounted device to a value greater than the nominal current value.

In some aspects, the techniques described herein relate to a method, further including: momentarily increasing and then decreasing the current value applied to the MR brake as a user changes the angular position of the mounted device to provide feedback to the user that mimics a detent.

In some aspects, the techniques described herein relate to a method, further including: determining a current angular position of the mounted device; and increasing or decreasing the current value applied to the MR brake to maintain the current angular position of the mounted device.

In some aspects, the techniques described herein relate to a mobile computing device docking station including: a magneto-rheological (MR) brake including a magnetic field source and reservoir including MR fluid; a position sensor; a processor; and a memory having instructions stored thereon that, responsive to execution by the processor, cause the mobile computing device docking station to execute a method described herein.

In some aspects, the techniques described herein relate to an apparatus including: a processor; and a computer-readable storage medium (CRM) having stored thereon instructions that, responsive to execution by the processor, cause the processor to perform a method described herein.

This Summary is provided to introduce simplified concepts for docking station articulation, which is further described below in the Detailed Description and is illustrated in the Drawings.

### BRIEF DESCRIPTION OF THE DRAWINGS

The details of one or more aspects of docking station articulation are described in this document with reference to the following Drawings. In the Drawings, the use of same numbers in different instances may indicate similar features or components.

FIG. 1A is a front view of an example system that includes a docking station and a mobile computing device, which illustrates the mobile computing device unmounted from the docking station;

FIG. 1B is a front view of the example system of FIG. 1A, which illustrates the mobile computing device mounted to the docking station and in a support position;

FIG. 1C is a front view of the example system of FIG. 1A, which illustrates the mobile computing device mounted to the docking station and in a resting position;

FIG. 1D is a side view of the example system of FIG. 1A, which illustrates a transition from the support position to the resting position;

FIG. 2A is an example schematic diagram of a mobile computing device;

FIG. 2B is an example schematic diagram of a docking station;

FIG. 3 is a schematic front view of the example system of FIG. 1C;

FIG. 4A is a first side view of another example system that includes a docking station and a mobile computing device, which illustrates the system in a first support position;

FIG. 4B is a second side view of the example system of FIG. 4A, which illustrates the system in a second support position;

FIG. 4C is a third side view of the example system of FIG. 4A, which illustrates the system in a resting position;

FIG. 5 is a side view of another example system;

FIG. 6 is a side view of an additional example system;

FIG. 7 is a flowchart of an example process for docking station articulation;

FIG. 8 is a flowchart of an example process for docking station articulation;

FIG. 9 is a flowchart of an example process for docking station articulation;

FIG. 10 is a flowchart of an example process for docking station articulation; and

FIG. 11 illustrates various components of an example computing system that can be implemented as any type of client, server, and/or electronic device as described with reference to FIGS. 1-10 to implement, or in which techniques may be implemented that enable, an articulated docking station for a mobile computing device.

### DETAILED DESCRIPTION

### Overview

This document describes techniques and apparatuses for docking station articulation. In aspects, the techniques and apparatuses are implemented in a docking station (“dock”) that is configured to mountingly receive a mobile computing device (“device”). In such a configuration, the device is “mounted” on the dock. In general, the term “mounted” refers to the device positioned in, at, on, relative to, and/or adjacent to the dock. A mounted connection between the device and the dock may be fixed or movable, temporary or permanent, and/or direct or indirect. A user can place such a mobile device in a dock to power a battery of the device, to support the mobile device relative to a surface (e.g., a countertop), and/or to supplement the functionality of the device (e.g., to stream audio to larger speakers built into the dock).

In some aspects, a dock may include a hinged portion (e.g., a hinge assembly) that enables the mobile device to be articulated on the hinge to adjust a viewing angle of a display of the mobile device. Based on an identity of the device mounted on the dock, a torque applied by the hinge assembly is dynamically adjusted based on the device being mounted and/or based on user preference. In this way, the techniques and apparatuses may provide a universal articulated dock that can be utilized with many different size, weight, and form factors of mobile computing devices. The techniques and apparatuses may provide a dock that can support a heavy mobile computing device while allowing for smooth articulation (e.g., rotational movement) of the mounted device by a user, making the dock easier to use by people with disabilities and by children. Further, the techniques and apparatuses may provide a dock configured to magnetically attach to a device, which decreases the chances that the device will accidentally unmount from the dock if the magnetic retention force is lower than the torque being applied by the hinge assembly. In these ways, the techniques and apparatuses may improve the quality of a user's experience in using the device and/or dock. These are but a few examples of how the described techniques and apparatuses may be used for docking station articulation. Other examples and implementations are described throughout this document.

### Example Apparatuses and Systems

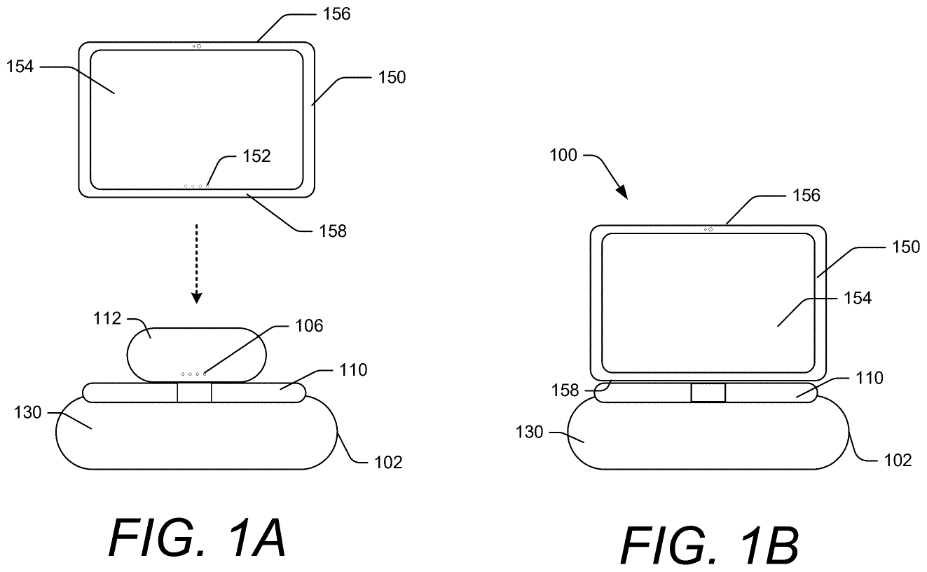

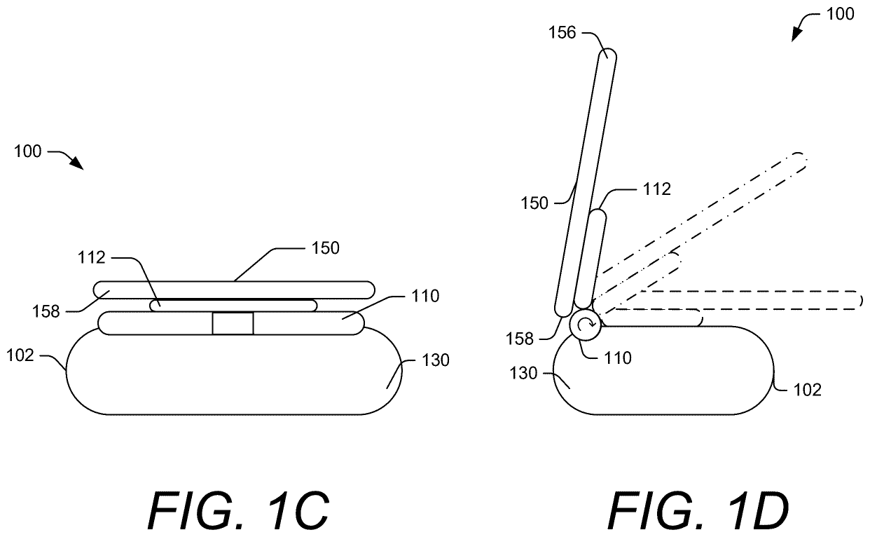

FIGS. 1A-1D illustrate a system 100 that includes a dock 102 and a mobile computing device 150 (device 150). The dock 102 may be adapted to receive the device 150 when the dock 102 is positioned on a surface (e.g., on a countertop). In these figures, the dock 102 takes a familiar form of an appliance that can be plugged into a standard electrical outlet and that may include a device charger, amplifiers, and speakers, among other things. A user of the device may mount the device 150 to the dock 102, for example, to charge a battery of the device 150 and to route an audio signal to a speaker system of the dock 102. These figures schematically illustrate a system in which a connection between the device 150 and the dock 102 may be made upon mounting the device 150 to the dock 102. The formation of the connection may trigger one or more actions of the docking station 102 to occur, as described herein.

In FIG. 1A, the system 100 is illustrated where the device 150 is not mounted to the dock 102. In the aspect illustrated, the device 150 is positioned to be lowered onto the dock 102. The device 150 may include a distal end 156 opposite a proximal end 158. In the aspect illustrated in FIG. 1A, the distal end 156 is a top side of the device 150 and the proximal end 158 is a bottom side of the device 150. In such a description, the uses of “top” side and “bottom” side are relative to a user facing a display 154 of the device 150 and are used merely to indicate one example of how a user might position a device on a dock.

The docking station 102 includes a hinge assembly 110 that is configured to provide a hinged connection between the dock 102 and the device 150. In the aspect illustrated in FIGS. 1A-1D, the dock 102 includes a body 130 that is hingedly connected to a device support 112 (support 112) at the hinge assembly 110. The support 112 may include a platform, a mounting portion, a cradle, and the like. The support 112 is configured to connect (e.g., physically connect) with the device 150. For example, the support 112 may be a dock that receives the device 150, the device 150 may magnetically attach to the support 112, the device 150 may mechanically attach (e.g., by clamping, by a friction-fit) to the support 112, and the like. In the aspect illustrated in FIGS. 1A-1D, one or more of the dock 102 or the device 150 include magnets that magnetically attach the device 150 to the support 112 of the dock 102.

Via the hinge assembly 110, the support 112 is configured to rotate relative to the body 130 of the dock 102 about an axis of rotation. The axis of rotation of the support 112 may be a fixed axis of rotation. The rotation enables the device 150 mounted on the dock 102 to be oriented in one or more angular positions relative to the dock 102 (e.g., relative to the body 130 of the dock 102). A first angular position may be a support position where a first side (e.g., distal end 156) of the device 150 is supported in a position spaced apart from the dock 102, for example, as illustrated in FIG. 1B where the device 150 is positioned vertically with the distal end 156 spaced apart from the dock 102. A second angular position may be a resting position where the first side (e.g., distal end 156) of the device 150 is supported in a position that is adjacent to the dock 102, for example, as illustrated in FIG. 1C where the device 150 is positioned horizontally with the distal end 156 (hidden from view in FIG. 1C) adjacent to the dock 102. In the resting position illustrated in FIG. 1C, the device 150 may be held in the dock 102 at an angular position where the distal end 156 is positioned generally level with the proximal end 158. These angular positions are further illustrated in FIG. 1D, which is a side view of the example system of FIG. 1A. FIG. 1D illustrates a transition from a first support position (in solid lines) to a second support position (in dash-dotted lines) and to a resting position (in dashed lines). In the resting position, the support 112 and/or the device 150 may contact the body 130 of the dock 102 for physical support.

In a support position, the angular position of the device 150 relative to the dock 102 may be positively supported by the hinge assembly 110. For example, in the support position, the hinge assembly 110 may be configured to prevent or inhibit the rotation of the support 112 relative to the body 130 of the dock 102 about the axis of rotation of the support 112. In doing so, the hinge assembly 110 positively supports the angular position of the device 150. In a resting position, the angular position of the device 150 relative to the dock 102 may not be positively supported by the hinge assembly 110. For example, in the resting position, the hinge assembly 110 may not prevent or inhibit the rotation of the support 112 relative to the body 130 of the dock 102 about the axis of rotation of the support 112. In doing so, the hinge assembly 110 may not positively support the angular position of the device. It can be said that the hinge assembly 110 is “collapsed” in such a configuration.

In FIG. 1A, the support 112 is illustrated in a first orientation where the device 150 is not mounted to the dock 102. In FIG. 1C, the support 112 is illustrated in a second orientation where the device 150 is mounted to the dock 102. In FIG. 1D, the support 112 is illustrated in multiple orientations, with the device 150 mounted to the dock 102. In the first orientation, the support 112 is spaced apart from the body 130 of the dock 102, in comparison to the second orientation where the support 112 is illustrated as positioned near the body 130 of the dock. In other aspects, the support 112 may be positioned in the second orientation when the device 150 is not mounted.

In the absence of detecting a force applied to the device 150 (e.g., the application of a force by a user to change a position of the device 150), the hinge assembly 110 may maintain the device 150 in the support position. The support position may include an angular position of the device 150 where the distal end 156 is positioned above the proximal end 158 or the proximal end 158 is positioned above the distal end 156, for example, at an oblique angle or at a right angle. In the aspect of FIG. 1B, the distal end 156 is illustrated as positioned above the proximal end 158. A user may position the system 100 in the support position to orient the display 154 of the device 150 in a user-selected viewing angle relative to a surface upon which the dock 102 is positioned.

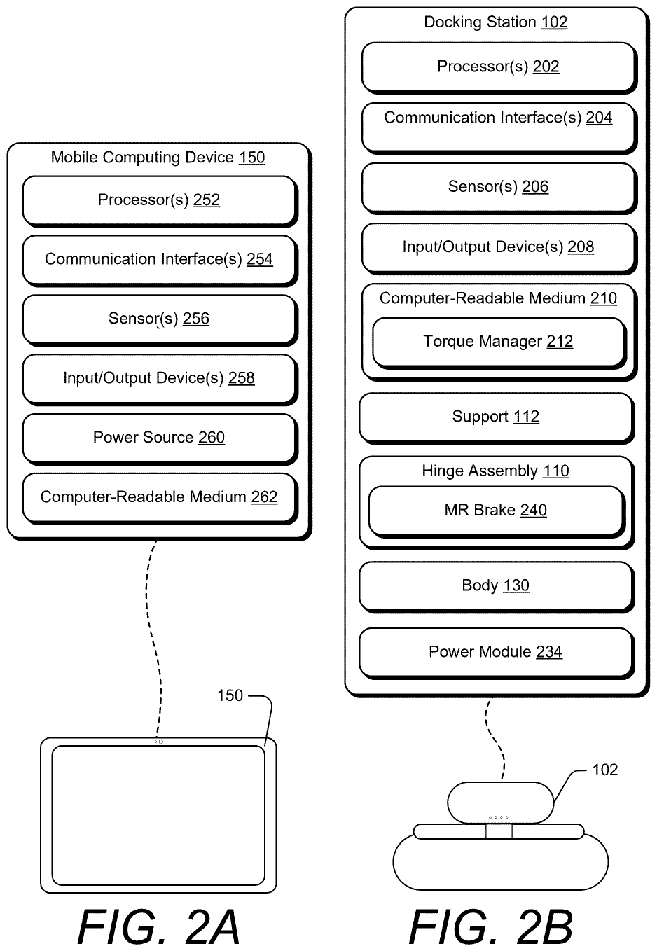

FIG. 2A is an example schematic diagram of a mobile computing device 150 (device 150). The device 150 includes processor(s) 252, communication interface(s) 254 for transmitting data to and receiving data from a dock 102, sensor(s) 256, input/output device(s) 258 (e.g., display, speaker, microphone), and a power source 260 (e.g., rechargeable battery). The sensor(s) 256 may include, but are not limited to, touch sensors, inertial sensors, location sensors, position sensors (e.g., Hall effect sensors (“Hall sensors”), inductive sensors, proximity sensors, optical sensors), and the like. The communication interface(s) 254 may include one or more network interface components or other suitable devices to communicate with another device (e.g., the dock 102) via a data connection. For example, the communication interface(s) 254 may include wired communication components, cellular communication components, ultra-wide band (UWB) components, Near Field Communication (NFC) components, Bluetooth® components (e.g., Bluetooth®, Bluetooth® Low Energy), wireless local area network (WLAN) components (e.g., IEEE 802.11 standard), and/or other communication components. The communication interface(s) 254 may be utilized by the device 150 in order to communicate with the dock 102. The device 150 may also include a computer-readable medium 262 (CRM 262). The CRM 262 may include any suitable memory or storage device (e.g., random-access memory (RAM), static RAM (SRAM), dynamic RAM (DRAM), non-volatile RAM (NVRAM), read-only memory (ROM), flash memory), a mass storage media device, and/or a disk storage device. A disk storage device may be implemented as any type of magnetic or optical storage device, such as a hard disk drive, a recordable and/or rewriteable compact disc (CD), any type of a digital versatile disc (DVD), and the like. Device data (e.g., user data, device identity information) may be stored on the CRM 262.

FIG. 2B is an example schematic diagram of the docking station 102 (dock 102). The dock 102 includes processor(s) 202, communication interface(s) 204 for transmitting data to and receiving data from the device 150, sensor(s) 206, and input/output device(s) 208 (e.g., speaker system). The sensor(s) 206 may include, but are not limited to, touch sensors, inertial sensors, location sensors, position sensors (e.g., Hall effect sensors (“Hall sensors”), inductive sensors, proximity sensors, optical sensors), and the like.

The communication interface(s) 204 may include one or more network interface components or other suitable devices to communicate with another device (e.g., the dock 102) via a data connection. For example, the communication interface(s) 204 may include wired communication components, cellular communication components, UWB components, NFC components, Bluetooth® components, WLAN components, and/or other communication components. The communication interface(s) 204 on the dock 102 and the communication interface(s) 254 on the device 150 may establish a data connection between the dock 102 and the device 150. The data connection may be utilized for data communication between the dock 102 and the device 150 (e.g., to share device data, to transfer an audio signal from the device 150 to a speaker system of the dock 102, and the like). The data connection between the dock 102 and the device 150 may be established responsive to mounting of the device 150 to the dock 102. The data connection may be a wireless data connection and/or a physical data connection.

In aspects, a wireless data connection (e.g., wireless communication channel) between the device 150 and the dock 102 may be established using the communication interfaces (e.g., communication interface 204, communication interface 254) in order for the dock 102 and the device 150 to communicate by one or more modes (e.g., UWB, NFC, Bluetooth®, WLAN (aka “Wifi”)). A wireless data connection may be formed before or after a physical connection and/or physical data connection between the dock 102 and the device 150. In aspects, a wireless data connection may be formed responsive to a detection of a physical connection and/or physical data connection between the dock 102 and the device 150. A wireless data connection may be created when the dock 102 and mobile computing device 150 are physically connected.

Mounting the device 150 to the dock 102 may result in a physical data connection between the device 150 and the dock 102. For example, a dock data terminal 106 on the dock 102 may engage a device data terminal 152 of the device 150. Such a physical data connection may be utilized to provide power from the dock 102 to the device 150 and/or to transfer data between the dock 102 and the device 150. For example, a first data terminal may provide a positive voltage electrical current, a second data terminal may provide a reference voltage (e.g., ground), a third data terminal may be used for data communication, etc. In the aspect illustrated in FIG. 1A, the dock data terminals 106 are illustrated as pogo pins (e.g., spring-loaded pins) located on the dock 102 and the device data terminals 152 are illustrated as contacts located on the device 150 (e.g., on a back side of the device 150), with the pogo pins configured to interface with the contacts.

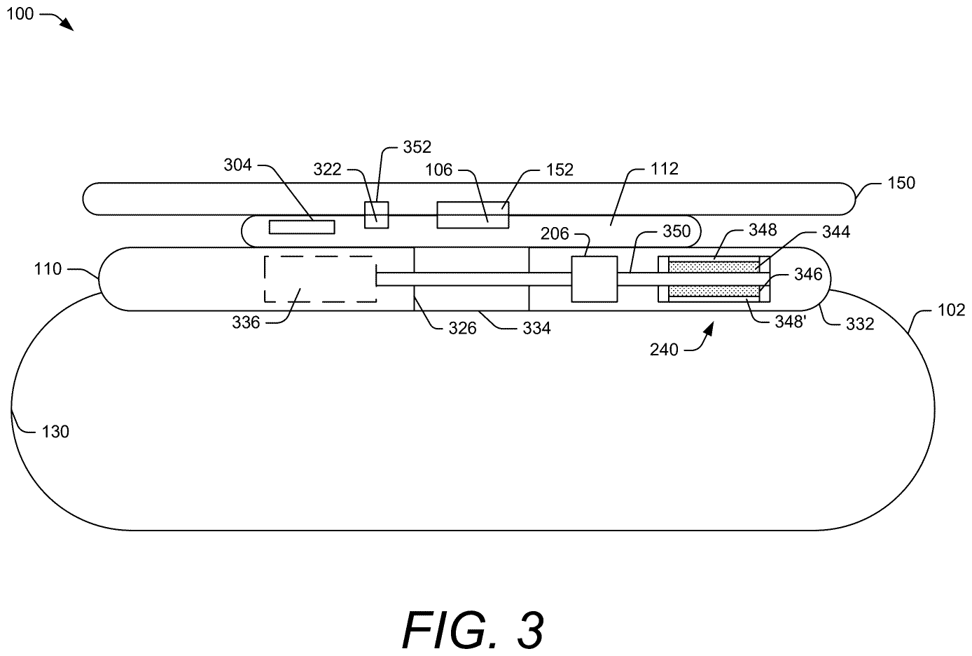

FIG. 3 is a schematic front view of the example system 100. In the aspect illustrated in FIG. 3, the dock 102 includes at least one sensor 206 that is configured to determine at least one of a position of the mounted device 150, a position of the hinge assembly 110, a position of the support 112, or the like. The sensor 206 may measure a direction of rotation (e.g., clockwise, counter-clockwise) of the hinge assembly 110, for example, a direction of rotation of a hinge shaft 350. In one example, the sensor 206 measures the direction of rotation of the hinge assembly 110 to determine a force (e.g., a rotational force) applied by a user to reposition the hinge assembly 110. In another example, the sensor 206 may measure a rotational or other force applied to the hinge assembly 110 by a user to reposition the device 150 mounted on the dock 102.

The sensor 206 may measure an angular position. For example, the sensor 206 may measure the angular position of the mounted device 150 relative to the axis of rotation (e.g., positioned vertically, positioned horizontally, positioned at a 45° angle) of the support 112. The angular position measured may include one or more of a position of the mounted device 150, a position of the hinge assembly 110, a position of the support 112, and the like.

The dock 102 may include a mounting sensor that is configured to determine whether a device is present (e.g., whether a device is mounted on the dock). For example, as illustrated in FIG. 3, the support 112 of the dock 102 may include a position sensor 304 that determines a presence and/or an absence of the device 150 on the dock 102.

The dock 102 may also include a computer-readable medium (CRM) 210. The CRM 210 may include any suitable memory or storage device (e.g., RAM, SRAM, DRAM, NVRAM, ROM, flash memory), a mass storage media device, and/or a disk storage device. A disk storage device may be implemented as any type of magnetic or optical storage device, such as a hard disk drive, a recordable and/or rewriteable compact disc (CD), any type of a digital versatile disc (DVD), and the like. Device data (e.g., user data, applications, modules) is stored on the CRM 210. The device data may include instructions that, responsive to execution by a processor (e.g., processor(s) 202), cause the processor to perform operations to implement a method described in this publication.

The device data on the CRM 210 may include executable instructions of a torque manager 212 (e.g., application, operating system) that may be executed by the processor(s) 202. The torque manager 212 manages docking station articulation, for example by managing the torque that is applied by the hinge assembly 110. In aspects, the torque is managed by dynamically adjusting the torque that is applied by the hinge assembly 110. The torque applied by the hinge assembly 110 may be adjusted based on an identity of the device 150 mounted on the dock 102 and/or based on a user preference. In aspects, the torque manager 212 represents functionality that receives sensor data (e.g., touch sensor data, inertial sensor data) from a sensor (e.g., sensor 206, sensor 256) and utilizes the received data to manage docking station articulation.

The hinge assembly 110 illustrated in FIGS. 2 and 3 includes an actuator that is configured (e.g., by the torque manager 212) to dynamically adjust the torque that is applied by the hinge assembly 110, for example, by dynamically adjusting the torque applied by the hinge assembly 110 as a user manipulates a position of a mounted device (e.g., device 150). In aspects, the actuator may include a magneto-rheological hinge brake 240 (“MR brake 240”). In the schematic illustration of FIG. 3, the MR brake 240 is located in a housing 332 and includes a reservoir 346 that contains an MR fluid 344 (e.g., an inert carrier liquid, oil) and suspended magneto-rheological material (MRM). The MRM, also known as magneto-sensitive smart material, may include particles of iron, nickel, cobalt, carbonyl iron powder, and the like. When a magnetic field is applied to the MR fluid 344, particles of the MRM align themselves along lines of magnetic flux, resulting in a change to a material property of the MR fluid 344. The MR fluid 344 may have a low viscosity in the absence of an applied magnetic field and may have an increased apparent viscosity, to the point of becoming a viscoelastic solid (e.g., quasi-solid), when subjected to a magnetic field. The magnetic field may be adjusted (e.g., increased, decreased, maintained) to maintain a current position (e.g., to maintain a current angular position of the mounted device 150).

A magnetic field source (e.g., magnetic field source 348, magnetic field source 348′), for generating a magnetic field, is positioned in the housing 332 (e.g., adjacent to the reservoir 346). The magnetic field source may include at least one electromagnetic coil wound around (e.g., around the reservoir 346) and/or located within the housing 332.

The dock 102 may include a power module 234 configured to supply an electrical current. For example, the power module 234 may apply an electrical current (e.g., a current value) to the magnetic field source 348 to generate a magnetic field. The power module 234 may connect with mains electricity or another power source. The power module 234 may include a device charger that is configured to supply power (e.g., voltage) to a power source 260 (e.g., battery) of the device 150, for example though a wired or wireless charging connection. A wired charging connection may include a physical data connection. The supplied voltage may be further utilized to power the device 150 when it is mounted to the dock 102. The torque manager 212 may control the supplied electrical current and resulting magnetic flux to configure the MR brake 240 to dynamically adjust the torque that is applied by the hinge assembly 110 (e.g., by controlling the power module 234, by controlling a current amplifier that is electrically connected to the magnetic field source 248, and the like).

The MR brake 240 utilizes rheological properties of the MR fluid 344 to apply a variable response force to the hinge shaft 350. The hinge shaft 350 extends through the reservoir 346 of MR fluid 344. Upon activation of the magnetic field source 348 (e.g., by introduction of an electrical current), a magnetic field is generated (e.g., inside the housing 332) and the MR fluid 344 in the reservoir 346 changes phase and becomes a viscoelastic solid. The increased apparent viscosity of the MR fluid 344 provides a responsive force that is resistant to movement (e.g., the force is resistive to the rotation of the hinge shaft 350), resulting in controllable friction from the MR fluid 344 to the hinge shaft 350 that slows or stops the rotation of the hinge shaft 350. In such a configuration, the hinge shaft 350 is a damping shaft. By varying the magnetic field intensity applied by the magnetic field source 348, for example, by increasing or decreasing an electrical current supplied to the magnetic field source 348, the hinge shaft 350 of the MR brake 240 may be selectively damped.

In FIG. 3, the hinge shaft 350 is illustrated as a straight shaft. In other aspects, a shaft may include a rotary disc or other structure mechanically interconnected therewith and/or extending therefrom that is configured to engage with the MR fluid 344. In other aspects, a shaft damped by the MR brake 240 may be a shaft separate from the hinge shaft 350 of the hinge assembly 110.

In aspects, the actuator that is configured (e.g., by the torque manager 212) to dynamically adjust the torque that is applied by the hinge assembly 110 may include an electric motor (e.g., direct current (DC) motor). FIG. 3 illustrates an example DC motor actuator 336 in dotted-line fashion. The DC motor actuator 336 may be configured to apply a variable response force to the hinge shaft 350 to rotate the hinge assembly 110 and/or hinge shaft 350. For example, the DC motor actuator 336 may connect with the hinge shaft 350 and a rotation of the DC motor actuator 336 may apply a force to the hinge shaft 350 to cause and/or oppose a rotation of the hinge shaft 350 in a first direction or a second direction.

The torque manager 212 may represent functionality that determines an angular position of the device 150 relative to the body 130 of the dock 102 at the hinge assembly 110. For example, the torque manager 212 may receive position sensor data measured by a sensor (e.g., sensor 206, sensor 256). The position sensor data may include an angular position of the mounted device 150 relative to the axis of rotation (e.g., positioned vertically, positioned horizontally, positioned at a 45° angle) of the support 112. The position sensor data may include one or more of a position of the mounted device 150, a position of the hinge assembly 110, a position of the support 112, and the like.

The torque manager 212 may represent functionality that determines a current angular position of the mounted device 150 and modifies (e.g., increases, decreases) the current value applied to the MR brake 240 to maintain the current angular position of the mounted device 150. The torque manager 212 may represent functionality that stores a history of previous angular positions (e.g., over several preceding usage sessions by a user) as stored position sensor data on the CRM 210. The torque manager 212 may utilize the stored position sensor data to determine at least one angular resting position of the mounted device 150. The determined angular resting position may be indicative of a user-preferred angular docking position. In one example, the torque manager 212 may momentarily increase the hinge torque when the user reaches the determined angular resting position to indicate to the user that they have reached a previously used articulation. In another example, the torque manager 212 may momentarily increase the current value applied to the MR brake 240 when a user-induced motion reaches the determined angular resting position to provide feedback (e.g., haptic feedback, tactile feedback) to the user of the stored angular resting position. In another example, the torque manager 212 may increase the current value applied to the MR brake 240 when the user-induced motion reaches the determined angular resting position to resist the user-induced motion (e.g., rotation of the support 112 relative to the body 130 of the dock 102 about the axis of rotation) beyond the determined angular resting position.

Rotating wheels and dials may often have mechanical detents to provide a user with tactile feedback for step response change to input (e.g., rotational input) by the user. Detents may also be enabled in an articulation design dynamically to provide a user with tactile feedback that provides the user with a feeling of precise control. The torque manager 212 may represent functionality that detects (e.g., via a sensor) a change in the angular position of the mounted device 150 and provides at least one virtual detent to a user as feedback (e.g., haptic feedback, tactile feedback). In aspects, multiple virtual detents may be spaced apart at a fixed interval(s). For example, multiple virtual detents may be spaced out (e.g., a detent every 2 degrees, 5 degrees, 10 degrees, and the like) along the axis of rotation of the support 112. The torque manager 212 may detect (e.g., via a sensor) a change in the angular position of the mounted device 150 and provide to a user, at one or more positions or intervals of positions along the axis of rotation, a virtual detent as feedback.

During motion of the device 150 along the axis of rotation of the support 112, a rapid short burst of increased torque may present a virtual detent that simulates a mechanical detent. In one example, the torque manager 212 may detect an angular position change and, at known fixed intervals along the axis of rotation of the support 112, momentarily increase the hinge torque to simulate mechanical detents. In another example, the torque manager 212 momentarily increases the current value applied to the MR brake 240 when the user-induced motion reaches a virtual detent position to provide feedback (e.g., haptic feedback, tactile feedback) to the user of the virtual detent position. In other aspects, the torque manager 212 represents functionality that momentarily increases and then decreases the current value applied to the MR brake 240 as a user changes the angular position of the mounted device 150 to provide feedback to the user of the virtual detent positions. The detents may be positioned based on prior interaction with the user or prior use of the system by the user.

The torque manager 212 may represent functionality that implements a hinge position lock that locks an angular position of the hinge assembly 110 and prevents further articulation of the hinge assembly 110. A hinge position lock may be enabled responsive to receiving input from a user to lock the angular position of the mounted device 150 (e.g., via a user interface). In an example, responsive to receiving the user input to lock an angular position of the mounted device 150, the torque manager 212 may increase the current value applied to the MR brake 240 (e.g. to a value greater than the nominal current value) at the current angular position to resist or prevent further user-induced motion (e.g., rotation of the support 112 relative to the body 130 of the dock 102 about the axis of rotation). In an example use case, a user may provide user input to implement a child lock that locks the current angular position to prevent misuse of and/or damage to the hinge assembly 110 by a child.

The torque manager 212 may represent functionality that determines if a device is mounted on the dock 102, for example, determining a mounting state of the dock 102 (e.g., whether the device 150 is mounted with the dock 102 (a “mounted state”), whether the device 150 is unmounted from the dock 102 (an “unmounted state”)). The mounting state may be determined by detecting a physical connection of the device 150 to or a physical disconnection of the device 150 from the dock 102. For example, a sensor 206 of the dock 102 (e.g., position sensor 304 in the support 112) and/or a sensor 256 of the device 150 may determine the presence or absence of the device 150 on the dock 102. The torque manager 212 may use data (e.g., position sensor data, touch sensor data, inertial sensor data) from such a sensor to determine the mounting state of the dock 102. The mounting state may be determined by the dock 102 sensing power at an electrical power input (e.g., at a wired or wireless charging connection between the dock 102 and the device 150). Sensing power at the electrical power input may include sensing an input voltage above a threshold level at the electrical power input, the dock 102 or device 150 receiving an indication that the device 150 has begun to charge, the dock 102 or device 150 receiving an indication that voltage is present on an electrical bus that provides power for charging the device 150, etc. The mounting state may be determined by the dock 102 receiving a communication from the device 150 that indicates a mounted status.

The torque manager 212 may represent functionality that establishes a wireless data connection between the dock 102 and a device 150, for example using the communication interfaces (e.g., communication interface 204, communication interface 254). The wireless connection may be established responsive to a determination that the device 150 is mounted on the dock 102. The wireless data connection may enable the dock 102 and the device 150 to communicate by one or more modes (e.g., UWB, NFC, Bluetooth® (e.g., BT, BLE), WLAN (aka “Wi-Fi”)). The wireless communication may be at least one of a UWB, NFC, Bluetooth® (e.g., BT, BLE), or WLAN (aka “Wi-Fi”) wireless communication. The functionality may also include transmission of data, by the dock 102 and to the device 150, as part of the wireless communication.

The torque manager 212 may represent functionality that determines a device type for the mounted device 150. The device type may be determined responsive to one or more of a determination that the device 150 has mounted on the dock 102 or the establishment of a data connection (e.g., a wireless data connection) between the device 150 and the dock 102. Through the determination of the device type, the torque manager 212 may determine at least one characteristic (e.g., size information, weight information, form factor information) of the device 150 that enables the dock 102 to manage docking station articulation, for example by managing the torque that is applied by the hinge assembly 110. The device type may be determined from a plurality of types of devices, for example, by performing at least some of the operations described herein.

The dock 102 may determine a device type for the device 150 through analyzing device identifier information for the device 150. The device identifier (“Device ID”) information may include one or more identifiers that are derived from hardware of the device or that are broadly associated with the device. For example, the Device ID may be a hardware identifier, an International Mobile Equipment Identity (IMEI), a Media Access Control (MAC) address, a Globally Unique Identifier (GUID), a vendor identifier that identifies the manufacturer/vendor of the device, and the like. The Device ID may be obtained by the dock 102 from the device 150 through electronic communication via a physical data connection and/or a wireless data connection. The torque manager 212 may utilize an established data connection (e.g., wireless data connection, physical data connection) between the dock 102 and the device 150 to identify a device type for the device 150. In aspects, the Device ID may be provided by the device 150 to the dock 102 when establishing a wireless data connection, for example, during an execution of a wireless handshaking function utilized to establish the wireless data connection. The Device ID may be provided by the device 150 to the dock 102 after a wireless data connection has been established. In aspects, the device 150 identifies itself to the dock 102 via a Bluetooth® (e.g., BLE, BT) communication, an NFC communication, and/or a UWB communication as the device 150 comes into proximity to the dock 102. In aspects, this identification takes place before the device 150 is mounted on the dock 102. In another aspect, the torque manager 212 may send a command to the device 150, via the data connection, that requests that the device 150 respond with a Device ID.

A device type for the device 150 may be determined in other ways. For example, the dock 102 may identify a type of the device 150 by determining whether one or more electrical contacts (e.g., dock data terminals) provided on the dock 102 correspond with one or more electrical contacts on the device 150 when the device 150 is mounted. In a comparable manner, magnets may be placed in the device 150 and/or dock 102, and attraction of the magnets to items placed in an opposite machine may be used to make determinations in a manner similar to that for the contacts just discussed.

The torque manager 212 may represent functionality that determines a device type for a device and adjusts the hinge torque based on the device type. For example, the torque manager 212 may, based on the determined device type, modify (e.g., increase, decrease) the current value applied to the MR brake 240 to maintain a current angular position of the mounted device 150.

The torque manager 212 may represent functionality that determines a torque to be applied by the hinge assembly 110. For example, the torque manager 212 may determine an initial hinge torque setting for supporting an angular position of the device 150 relative to the dock 102 (e.g., relative to the body 130 of the dock 102). The initial hinge torque setting for supporting the angular position of the device 150 is a setting which provides sufficient resistance to prevent rotation of the device 150 relative to the dock 102 without user action. For example, the resistance provided prevents the angular position from changing due to the force of gravity. The resistance provided may also be sufficient to prevent the angular position from changing due to changes in velocity, such as would normally be experienced on a train or aircraft. In this way, the device 150 may be supported in a desired angular position without being held in place by the user. Determining an initial hinge setting may include determining a hinge torque profile for the mobile computing device 150. The torque manager 212 may represent functionality that determines a hinge torque profile for the mounted mobile computing device 150. The hinge torque profile may be based on the identified device type for the device 150. The hinge torque profile may be utilized to dynamically adjust the torque applied by the hinge assembly 110. The hinge torque profile may include a set of information and/or data regarding torque settings for the hinge assembly 110. The hinge torque profile may be a set, list, or other collection of attributes inferred or otherwise determined for the mounted device 150. A hinge torque profile may include an amount of force an actuator (e.g., MR brake) needs to apply to a shaft to damp rotation of the shaft and hold a device in a current angular position. A hinge torque profile for a mounted device may be based on one or more characteristics (e.g., size information, weight information, form factor information) of the mounted device. For example, a hinge torque profile for a large device, which requires additional damping force to maintain an angular position, may include higher torque settings for the hinge assembly 110 than a hinge torque profile for a smaller device. A hinge torque profile may include a torque reverse force that resists further movement through a range of motion.

The hinge torque profile may include a nominal current value for applying to an MR brake 240 to generate a magnetic field that maintains an angular position of the mounted device 150 (to support the device in the support position). In aspects, the current value applied to the MR brake 240 to maintain the current (updated) angular position of the mounted device 150 is the nominal current value. Determining a hinge torque profile for the mobile computing device 150 may include at least one of receiving a device identifier from the mobile computing device 150 and looking up the device identifier in a lookup table to determine the hinge torque profile; determining a device identifier for the mobile computing device 150 and looking up the device identifier in a lookup table to determine the hinge torque profile; receiving the hinge torque profile from the mobile computing device 150; receiving user input and determining the hinge torque profile based on the user input; or applying a default hinge torque profile.

A hinge torque profile may be utilized by the torque manager 212 to control the behavior of the hinge assembly 110 in different situations (e.g., to manage the torque that is applied by the hinge assembly). In this way, a hinge torque profile may include settings to control the manner in which a dock behaves when, for example, a device is mounted to the dock, a position of a mounted device is changed by a user, a power state of a mounted device changes (e.g., a mounted device is powered off, a mounted device is out of battery), a mounted device is dismounted, and/or a known device is mounted on the dock.

The hinge torque profile may include one or more hinge torque settings (e.g., one or more current values for application by a magnetic field source to generate a magnetic field for the MR hinge brake 240). The hinge torque profile may include a table of hinge torque settings and angular positions (e.g., a lookup table (LUT) stored on the CRM 210 of the dock 102). As discussed above, an angular position may be the angular position of the mounted device 150 relative to the axis of rotation (e.g., positioned vertically, positioned horizontally, positioned at a 45° angle) of the support 112 and may include one or more of a position of the mounted device 150, a position of the hinge assembly 110, a position of the support 112, and the like. In this way, the hinge torque profile may provide hinge torque settings based on an angular position. The hinge torque profile may be defined based on user preferences or user-selected settings. For example, a user may select a desired hinge torque setting and/or angular position.

The torque manager 212 may utilize Device ID information to generate a hinge torque profile that is relevant for a form factor, size, and/or weight of the device 150. For example, the torque manager 212 may utilize Device ID information to look up a hinge torque profile for the device 150 (e.g., in a lookup table (LUT) stored on the CRM 210). The hinge torque profile may be provided by the device 150 to the dock 102 via an established data connection (e.g., via a wireless data connection).

The torque manager 212 may apply the hinge torque profile to the hinge assembly 110 to implement the docking station articulation described herein. For example, as described above, the torque manager 212 may control the supplied electrical current and the resulting magnetic flux to configure the MR brake 240 to dynamically adjust the torque that is applied by the hinge assembly 110.

The torque manager 212 may represent functionality that stores the determined hinge torque profile for the mobile computing device 150 (e.g., as device data on the CRM 210). The hinge torque profile may be stored on the CRM 262 of the device 150 as device data.

The torque manager 212 may generate a hinge torque profile by estimating an appropriate amount of torque needed for a device. For example, the torque manager 212 may leverage a closed loop position and torque adjustment routine to estimate a torque amount for a device. One example use case where generation of a hinge torque profile by estimating an appropriate amount of torque may be useful is where the device 150 is powered off or out of battery and a data connection between the device 150 and the dock 102 is not available.

In an example of generation of a hinge torque profile by estimation, the torque manager 212 applies a low nominal current value to the magnetic field source 348 to energize the magnetic field source 348 and generate a nominal magnetic field for the MR brake 240. The torque manager 212 then determines if the hinge assembly 110 (e.g., a shaft 350) is moving (e.g., whether the nominal current value is high enough to support the current angular position of the device 150 mounted on the dock 102 relative to the body 130). For example, the torque manager 212 may receive sensor data (e.g., position sensor data) from a sensor (e.g., sensor 206, sensor 256) and utilize the sensor data to determine motion of the hinge assembly 110. If position sensor data does not indicate motion, the torque manager 212 may continue to apply the nominal current value to the magnetic field source 348 to maintain the current angular position of the device 150 mounted on the dock 102 relative to the body 130. If the position sensor data indicates motion of the hinge assembly 110, the torque manager 212 may increase the current value applied to the magnetic field source 348 to a level above the nominal current value to increase a damping force (e.g., increase the torque) for the MR brake 240 and then re-determine if the position sensor data indicates motion of the hinge assembly 110. This process may be repeated until it is determined that the applied current value supports the current angular position of the device 150. Based on this estimation process, an estimated hinge torque profile may be created for the device 150. The estimated hinge torque profile may be saved (e.g., to the CRM) as a hinge torque profile for the device 150.

In another example of generation of a hinge torque profile by estimation, the torque manager 212 applies a low nominal current value to the magnetic field source 348 to generate a nominal magnetic field for the MR brake 240. The torque manager 212 then determines if the hinge assembly 110 (e.g., a shaft 350) is moving and further determines a direction of motion of the hinge assembly 110. For example, the torque manager 212 may receive position sensor data from a position sensor (e.g., sensor 206, sensor 256), determine a motion of the hinge assembly 110 (e.g., rotation of the shaft 350) from the sensor data, and determine a direction of the motion of the hinge assembly 110 from the sensor data. If the position sensor data does not indicate motion, the torque manager 212 may continue to apply the nominal current value to the magnetic field source 348 to maintain the current angular position of the device 150 mounted on the dock 102 relative to the body 130. If the position sensor data indicates motion of the hinge assembly 110 in a first direction (or second direction), the torque manager 212 may increase the current value applied to the magnetic field source 348 to a level above the nominal current value to increase a force (e.g., increase the torque (damping force)) of the MR brake 240, thereby damping movement in the first direction (and/or the second direction). The torque manager 212 may then re-determine if the position sensor data indicates motion of the hinge assembly 110 and further increase the current value (e.g., an applied current value) if needed to damp the movement of the hinge assembly 110. This process may be repeated until it is determined that the applied current value supports the current angular position of the device 150. Based on this estimation process, an estimated hinge torque profile may be created for the device 150. The estimated hinge torque profile may be saved (e.g., to the CRM) as a hinge torque profile for the device 150. The first and second directions may be opposite directions (e.g., a clockwise direction and a counterclockwise direction, a counterclockwise direction and a clockwise direction).

A change to the angular position of the mounted device 150 relative to the axis of rotation of the support 112 may unbalance the hinge assembly 110. For example, a first current value may support the maintenance of a first angular position of the mounted device 150 but may not support the maintenance of a second angular position. For example, a user may apply a force to the mounted device 150 to change a position of the device 150 from a vertical position where the display 154 of the device 150 is orthogonal to the surface the dock 102 is resting on to a position where the display 154 of the device 150 is at a 45° angle to the surface. In the 45° angle position, the first current value may not be enough to maintain the angular position of the device 150, and the device/support may continue to move towards the resting position. An estimation process described herein may be used to balance the hinge assembly 110 and maintain the angular position of the device 150.

The torque manager 212 may utilize the Device ID information to determine whether the dock 102 has previously stored data (e.g., a stored hinge torque profile) for the device 150, for example, stored on the CRM 210. If the dock 102 has the stored data, the dock 102 may utilize the stored hinge torque profile. If the dock 102 does not have the stored data, the dock 102 generates a hinge torque profile for the device 150 utilizing the Device ID. In aspects, the dock 102 may use a default hinge torque profile for the device 150. The default hinge torque profile may be stored on the CRM 210.

The torque manager 212 may determine a device type for the mounted device 150 responsive to a determination of a mounting state of the dock 102 that indicates that the device 150 is mounted with the dock 102 (e.g., in a mounted state). For example, upon placing the device 150 on the dock 102 (aka “mounting the device”), the dock 102 may determine Device ID information and/or a hinge torque profile for the device 150.

The torque manager 212 may represent functionality that determines if a detected motion of the hinge assembly 110 is induced by a user (e.g., indicative of a force applied by a user to change a position of the device 150 (e.g., change a viewing angle of the device 150)). For example, after determining that a current value (e.g., the nominal current value, the applied current value) supports a current angular position of the device 150, the torque manager 212 may determine that the hinge assembly 110 (e.g., a shaft 350) is in motion. In aspects, the torque manager 212 may utilize position sensor data received from a position sensor (e.g., sensor 206, sensor 256) to determine a presence of a user-induced motion to change an angular position of the mounted device 150. That is, when a current value (e.g., the nominal current value, the applied current value) is being provided which is known to support the present angular position of the mounted device 150, but the hinge assembly 110 is moving so as to change the angular position of the mounted device 150, this movement is sufficient to assume that the motion is user-induced.

Responsive to the detected motion of the hinge assembly 110, the torque manager 212 may selectively increase (or decrease) the current value applied to the magnetic field source 348 to implement a “floating hinge.” For example, in detecting a motion of the hinge assembly 110 in a first direction, the torque manager 212 may decrease the current value applied to the magnetic field source 348 to a level below the currently applied current value and/or the nominal current value to decrease a damping force (e.g., decrease the torque) for the MR brake 240 while the user is moving a position of the mounted device 150. The decreased current value may be zero. In this way, it is easier for the user to change the angular position of the mounted device 150. The torque manager 212 may also represent functionality that increases the current value applied to the MR brake 240 at a level above the nominal current value to increase a damping force of the MR brake 240 and maintain the current (updated) angular position of the mounted device 150. The increased level may be the nominal current value.

The torque manager 212 may represent functionality that receives updated position sensor data from a position sensor and determines, utilizing the updated position sensor data, a cessation of the user-induced motion of the hinge assembly 110. The torque manager 212 may continue to utilize the position sensor data received from the position sensor (e.g., sensor 206, sensor 256) and continue to determine a motion of the hinge assembly 110. Responsive to a determination that the position sensor data no longer indicates motion (e.g., cessation of the user applying a force to move a position of the mounted device 150), the torque manager 212 may control a current value applied to the MR brake 240. For example, the torque manager 212 may apply a prior current value (e.g., the nominal current value, the applied current value) to the magnetic field source 348 to change the damping force (e.g., for rotation of the shaft) and maintain the current angular position of the device 150 mounted on the dock 102 relative to the body 130. The torque manager 212 may further utilize position sensor data to understand a direction force (e.g., clockwise direction force, counter-clockwise direction force) applied to the hinge 110 in order to dynamically adjust the torque in a specific direction, which will allow the hinge to produce a floating effect where the user needs to apply a minimum amount of force to rotate the hinge towards them without having the hinge collapse from the weight of the mobile computing device 150.

The torque manager 212 may represent functionality that implements a hinge collapse procedure. The hinge collapse procedure may be implemented over a period of time, so as to gradually transition the device 150 (e.g., if still mounted on the dock 102) and/or the device support 112 of the hinge assembly 110 from a support position to a resting position. In aspects, the hinge collapse procedure may be implemented upon a determination by the torque manager 212 of the presence of a hinge collapse condition (e.g., the unmounting of the mobile device 150 from the docking station 102 or interruption of a power source of the docking station 102). Upon detection of the hinge collapse condition, the torque manager 212 may reduce the hinge torque (e.g., by reducing or ceasing a current value) for applying to an MR brake of the docking station 102 to generate a magnetic field that maintains an angular position of the mounted device 150 (e.g., to support the device 150 in the support position), to cause the hinge assembly 110 to collapse under its own weight and transition to the resting position. In aspects, the torque manager 212 utilizes sensor data (e.g., data from a hall effect sensor) to detect that the mobile device 150 has unmounted from the docking station 102. The sensor data may also be used to turn off any charging-related activities of the docking station 102.

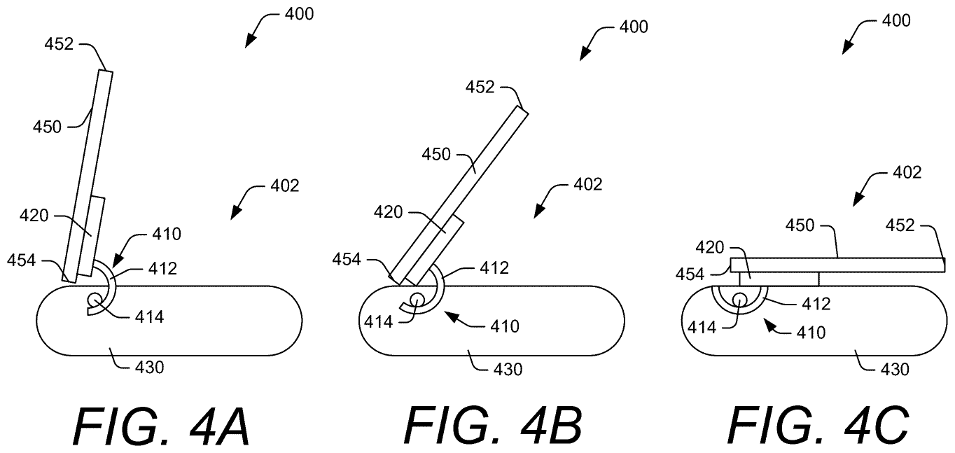

In FIG. 3, the device 150 is mounted to the dock 102 and oriented in a resting position where the first side (e.g., distal end 156, not visible in FIG. 3) of the device 150 is supported in a position that is adjacent to the dock 102. In this position, the hinge assembly 110 is in a collapsed state. In the example aspect illustrated in FIG. 3, the hinge assembly 110 includes a housing 332 and a barrel hinge assembly. The barrel hinge assembly includes a barrel portion 334 that is secured to the hinge assembly 110 by the hinge shaft 350, which is mounted in the housing 332. The barrel portion 334 attaches to the support 112 and in aspects may be integral with the support 112. The housing 332 may define a notch 326 that is configured to receive the barrel portion 334. Through the hinge shaft 350, the barrel portion 334 is rotatably mounted to the hinge assembly 110, so that rotation of the shaft 350 results in rotation of the barrel portion 334 and rotation of the barrel portion 334 at the hinge assembly 110 results in rotational movement of the support 112 relative to the body 130 (e.g., housing) of the dock 102, as is illustrated in FIG. 1D. While a barrel hinge is illustrated in FIG. 3, in other aspects, the hinge may be of another type. For example, FIGS. 4A-4C (discussed below) utilize a hinge assembly 410 that includes a rail 412 and a shaft 414 that engages the rail 412. In the aspect illustrated, the rail 412 is curved. The shaft 414 may include a roller, gear, or other structure configured to engage the rail 412.

Referring back to FIG. 3, the mounting of the device 150 on the dock 102 may result in a physical connection between the device 150 and the dock 102 (e.g., receipt of the device 150 onto the support 112). The physical connection may include a magnetic connection between the device 150 and the dock 102 that helps position and retain the device 150 on the dock 102 at the support 112. For example, as illustrated in FIG. 3, the device 150 may include at least one device magnet assembly 352 that may be configured for magnetic connection with at least one mating dock magnet assembly 322 on the support 112. In other aspects, the magnetic connection may include one or more magnet assemblies in the device 150 and/or dock 102 and may include ferro-magnetic material in one or both of the device 150 and the dock 102.

FIGS. 4A-4C illustrate another example system 400. The system 400 is similar to the system 100 illustrated in FIG. 1 and described above, except as detailed below. Thus, the system 400 includes a docking station 402 (dock 402) adapted to receive a mobile computing device 450 (device 450). The dock 402 includes a hinge assembly 410 that is configured to provide a hinged connection between the dock 402 and the device 450. The dock 402 includes a body 430 that is hingedly connected to a device support 420 (support 420) at the hinge assembly 410. The support 420 may include a platform, a mounting portion, a cradle, and the like. The support 420 is configured to connect (e.g., physically connect) with the device 450. For example, the support 420 may be a dock that receives the device 450, the device 450 may magnetically attach to the support 420, the device 450 may mechanically attach (e.g., clamped, friction-fit) to the support 420, and the like. The device 450 may include a distal end 452 opposite a proximal end 454. In the aspect illustrated in FIG. 4A, the distal end 452 is a top side of the device 450 and the proximal end 454 is a bottom side of the device 450. In such a description, the uses of “top” side and “bottom” side are relative to a user facing a display of the device 450 and are used merely to indicate one example of how a user might position a device on a dock.

Via the hinge assembly 410, the support 420 is configured to rotate relative to the body 430 of the dock 402 about an axis of rotation. The axis of rotation of the support 420 may be a fixed axis of rotation. The rotation enables the device 450 mounted on the dock 402 to be oriented in one or more angular positions relative to the body 430 of the dock 402. A first angular position may be a first support position where a first side (e.g., distal end 452) of the device 450 is supported in a position spaced apart from the dock 402, for example, as illustrated in FIG. 4A where the device 450 is positioned vertically with the distal end 452 spaced apart from the dock 402. A second angular position may be a second support position where the first side (e.g., distal end 452) of the device 450 is supported in a position spaced apart from the dock 402, for example, as illustrated in FIG. 4B where the device 450 is positioned at a lesser angle than what is illustrated in FIG. 4A, with the distal end 452 spaced apart from the dock 402. A third angular position may be a resting position where the first side (e.g., distal end 452) of the device 450 is supported in a position that is adjacent to the dock 402, for example, as illustrated in FIG. 4C where the device 450 is positioned horizontally with the distal end 452 adjacent to the dock 402. In the resting position illustrated in FIG. 4C, the device 450 is held in the dock 402 at an angular position where the distal end 452 is positioned generally level with the proximal end 454. In the resting position, the support 420 and/or the device 450 may contact the body 430 (e.g., housing) of the dock 402 for support. In a support position (e.g., the first support position or the second support position), the angular position of the device 450 relative to the dock 402 may be positively supported by the hinge assembly 410. For example, in the first support position of FIG. 4A and/or the second support position of FIG. 4B, the hinge assembly 410 may be configured to prevent or inhibit the rotation of the support 420 relative to the body 430 of the dock 402 about the axis of rotation of the support 420. In doing so, the hinge assembly 410 positively supports the angular position of the device 450. In the resting position, as illustrated in FIG. 4C, the angular position of the device 450 relative to the dock 402 may not be positively supported by the hinge assembly 410. For example, in the resting position, the hinge assembly 410 may not prevent or inhibit the rotation of the support 420 relative to the body 430 of the dock 402 about the axis of rotation of the support 420. In doing so, the hinge assembly 410 does not positively support the angular position of the device 450. It can be said that the hinge assembly 410 is “collapsed” in such a configuration. FIG. 4A illustrates the system 400 in the first support position, FIG. 4B illustrates the system 400 in the second support position, and FIG. 4C illustrates the system 400 in the resting position.

In contrast to the barrel hinge-style hinge assembly 110 illustrated in FIGS. 1A-3 and described above, the hinge assembly 410 illustrated in FIGS. 4A-4C includes a rail 412 and a shaft 414 that engages the rail 412. The rail 412 may be curved. The shaft 414 may include a roller, gear, or other structure that is configured to engage the rail 412. Rotation of the shaft 414 causes a movement of the rail 412. In other aspects, a hinge assembly may take another form or configuration. The example system 400 may use the same mechanisms described with respect to the example system 100 (shown in FIG. 3) for dynamically controlling the torque. For example, the MR brake 240 described with respect to FIG. 3 may be coupled to the shaft 414, or the rail 412, in order to provide braking as described above.

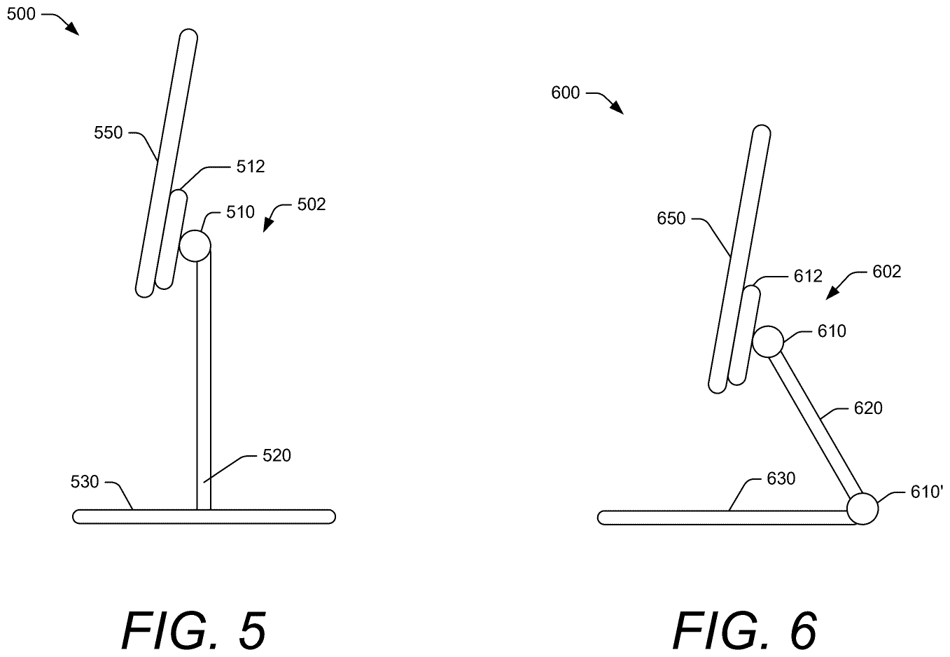

FIG. 5 and FIG. 6 illustrate additional system configurations that may implement the techniques and apparatuses directed at docking station articulation described herein. In FIG. 5, a system 500 is similar to the system 100 illustrated in FIGS. 1-3 and described herein, except as detailed below. Thus, the system 500 includes a docking station 502 (dock 502), a hinge assembly 510, and a support 512 configured to connect with a device 550. The dock 502 includes a support arm 520 and a base 530. Via the hinge assembly 510, the support 512 is configured to rotate relative to the dock 502 about an axis of rotation of the support 512. The rotation enables the device 550 mounted on the dock 502 to be oriented in one or more angular positions relative to the dock 502. The hinge assembly 510 may be configured like hinge assembly 110 described above.

In FIG. 6, system 600 is similar to the system 100 illustrated in FIGS. 1-3 and described herein, except as detailed below. Thus, the system 600 includes a docking station 602 (dock 602), a first hinge assembly 610, and a support 612 configured to connect with a device 650. The dock 602 includes a support arm 620 and a base 630. Via the first hinge assembly 610, the support 612 is configured to rotate relative to the dock 602 about an axis of rotation of the support 612. The rotation enables the device 650 mounted on the dock 602 to be oriented in one or more angular positions relative to the dock 602. The system 600 may include a second hinge assembly 610′ that hingedly connects the support arm 620 to the base 630. One or both of the first hinge assembly 610 or the second hinge assembly 610′ may be configured like the hinge assembly 110 described above.

### Example Methods

This section illustrates example methods, which may operate separately or together in whole or in part. The methods are illustrated as sets of operational blocks that specify operations performed but are not necessarily limited to the order or combinations shown for performing the operations. Further, one or more of the operations may be repeated, combined, reorganized, reordered, or linked to provide a wide array of additional and/or alternate methods. In portions of the following discussion, reference may be made to the example system 100 and/or dock 102 of FIGS. 1A, 1B, 1C, 1D, 2A, 2B, and 3 or to entities or processes as detailed in other figures, reference to which is made for example only. The techniques are not limited to performance by one entity or multiple entities operating on one device. The methods described herein may be computer-implemented methods.

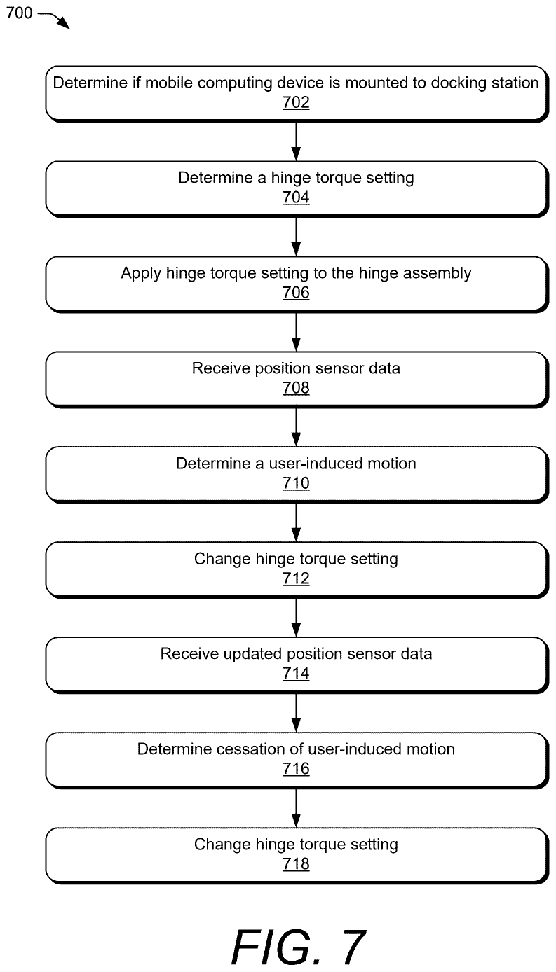

FIG. 7 is a flowchart of an example method 700 for controlling the articulation of a hinge assembly of a docking station. The described actions may occur upon a user physically placing a mobile device into a docking station, for example, as illustrated in FIGS. 1A and 1B. At 702, it is determined that a mobile computing device is mounted to a docking station. At 704, a hinge torque setting for supporting an angular position of the mobile computing device relative to the docking station is determined. At 706, the hinge torque setting is applied to a hinge assembly of the docking station to support the angular position of the mobile computing device relative to the docking station. At 708, position sensor data is received from a position sensor. At 710, the position sensor data is utilized to determine a user-induced motion to change the angular position of the mobile computing device to a new angular position. At 712, the hinge torque setting is changed to permit the user-induced change in the angular position of the mobile computing device to the new angular position. At 714, updated position sensor data is received from the position sensor. At 716, the updated position sensor data is utilized to determine a cessation of the user-induced motion. At 718, the hinge torque setting is changed to support the new angular position of the mobile computing device relative to the docking station.

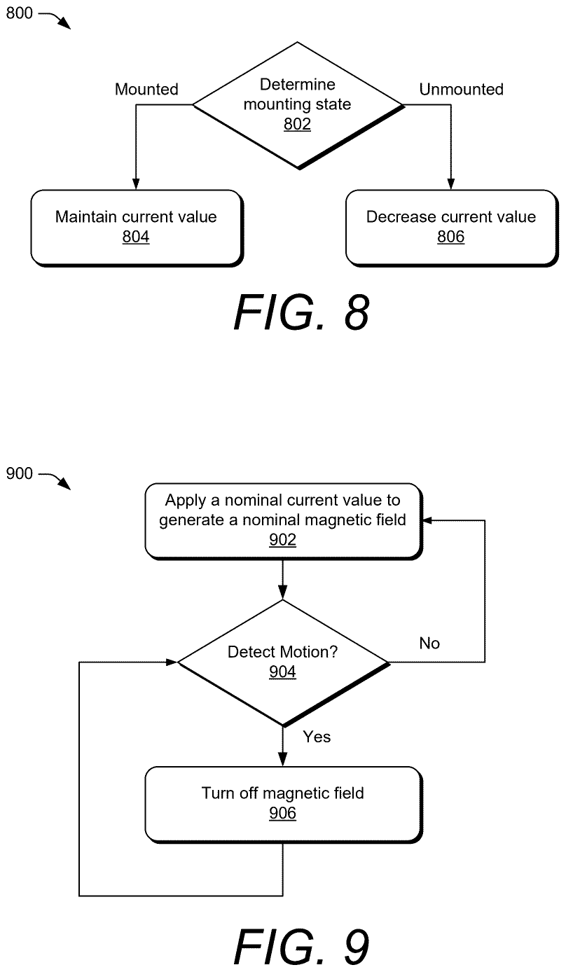

FIG. 8 shows a flowchart of an example process 800 for docking station articulation. The described actions may occur upon a user physically placing a mobile device into a dock, for example, as illustrated in FIGS. 1A and 1B. At 802, a mounting state of the dock 102 is determined. At 804, responsive to detecting a mounting state of the device 150 mounted on the dock 102, a current angular position of the device 150 mounted on the dock 102 may be maintained. For example, the torque manager 212 may apply a nominal current value to the magnetic field source 348 to cause the MR brake 240 to support a current angular position of the device 150 mounted on the dock 102 relative to the body 130 of the dock 102. At 806, responsive to detecting an unmounted state, the torque manager 212 may decrease a current value applied to the magnetic field source 348 to a level below the nominal current value to decrease a damping force for the MR brake 240, thereby permitting the hinge assembly 110 to collapse and transition from a support position to a resting position. Decreasing the current value may include a current value that turns off the magnetic field. In aspects, these actions are performed responsive to detecting an unmounted state after previously detecting a mounted state.

FIG. 9 shows a flowchart of an example process 900 for docking station articulation. The described actions may occur upon a user physically placing a mobile device into a dock, for example, as illustrated in FIGS. 1A and 1B. At 902, a nominal current value is applied to the magnetic field source 348 to generate a nominal magnetic field to cause the MR brake 240 to support a current angular position of the device 150 mounted on the dock 102 relative to the body 130 of the dock 102. At 904, it is determined whether position sensor data indicates a detection of motion. Optionally, the detection may include a direction of motion. If no motion is detected, the nominal magnetic field is maintained. If motion is detected, at 906, the magnetic field is turned off.

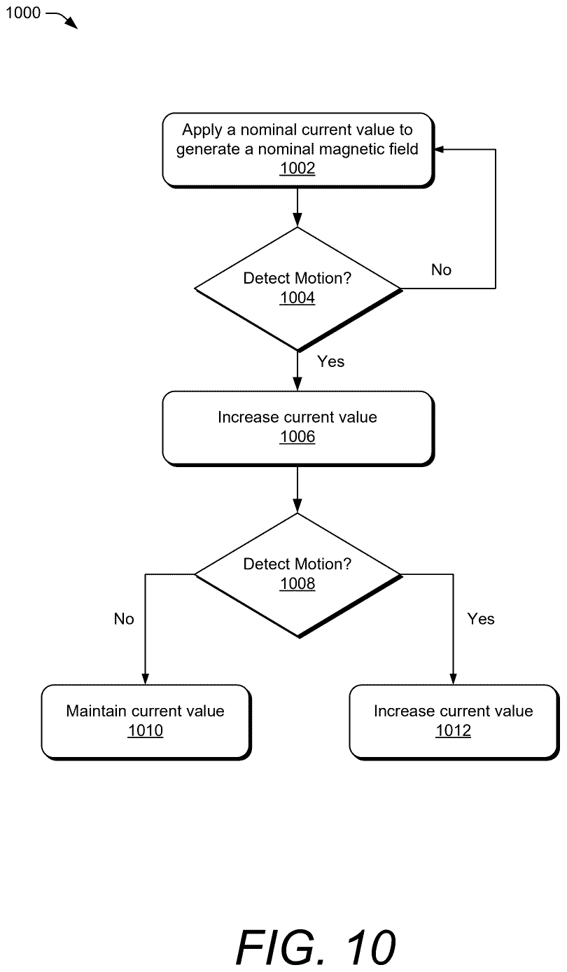

FIG. 10 shows a flowchart of an example process 1000 for docking station articulation. The described actions may occur upon a user physically placing a mobile device into a dock, for example, as illustrated in FIGS. 1A and 1B. The example process 1000 leverages a closed loop position and torque adjustment routine to estimate an appropriate amount of torque needed for the mobile computing device. At 1002, a nominal current value is applied to the magnetic field source 348 to generate a nominal magnetic field to cause the MR brake 240 to support a current angular position of the device 150 mounted on the dock 102 relative to the body 130 of the dock 102. At 1004, it is determined whether position sensor data indicates a detection of motion. Optionally, the detection may include a direction of motion. If no motion is detected, the nominal magnetic field is maintained. If motion is detected, at 1006, the current value is increased to increase the magnetic field to maintain the current angular position of the device 150 mounted on the dock 102 relative to the body 130 of the dock 102. At 1008, it is again determined whether position sensor data indicates the detection of motion. If no motion is detected, at 1010, the increased magnetic field is maintained. If motion is detected, at 1012, the current value is increased to increase the magnetic field to maintain the current angular position of the device 150 mounted on the dock 102 relative to the body 130 of the dock 102. One or more of these process operations may be repeated, as needed.

### Example Computing System

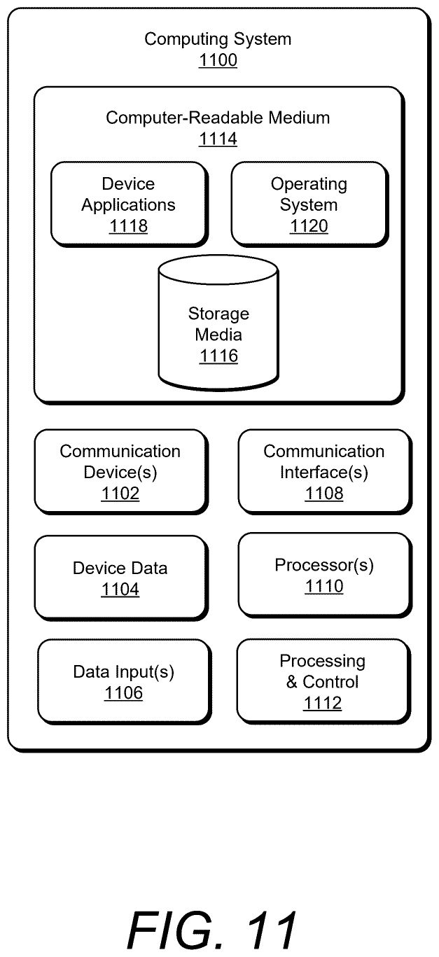

FIG. 11 illustrates various components of an example computing system 1100 that may be implemented as any type of client, server, and/or electronic device as described with reference to the previous FIGS. 1-10 to implement articulated docking stations for mobile computing devices.

The computing system 1100 includes communication device(s) 1102 that enable wired and/or wireless communication of device data 1104. The device data 1104 or other device content may include device identifier information, configuration settings, and the like. The computing system 1100 includes one or more data input(s) 1106 via which any type of data, device data, and/or inputs may be received from any content and/or data source. The data inputs 1106 may include, for example, user input on an input/output device. The computing system 1100 also includes communication interface(s) 1108. The communication interface(s) 1108 may be implemented as any one or more of a serial and/or parallel interface, a wireless interface, any type of network interface, a modem, and any other type of communication interface. The communication interface(s) 1108 provide a connection and/or communication links between the computing system 1100 and a communication network by which other electronic, computing, and communication devices communicate data with the computing system 1100.

The computing system 1100 includes one or more processors 1110 (e.g., any of microprocessors, controllers, or other controllers) that may process various computer-executable instructions to control the operation of the computing system 1100 and to enable techniques for, or in which may be implemented, articulated docking stations for mobile computing devices. Alternatively or additionally, the computing system 1100 may be implemented with any one or combination of hardware, firmware, or fixed logic circuitry that is implemented in connection with processing and control circuits, which are generally identified at 1112. Although not illustrated, the computing system 1100 may include a system bus or data transfer system that couples the various components within the system 1100. A system bus may include any one or combination of different bus structures, such as a memory bus or memory controller, a peripheral bus, a universal serial bus, and/or a processor or local bus that utilizes any of a variety of bus architectures.

The computing system 1100 also includes a computer-readable medium 1114 (CRM 1114), which may include any suitable memory or storage device (e.g., RAM, SRAM, DRAM, NVRAM, ROM, flash memory), a mass storage media device 1116 (storage media 1116), and/or a disk storage device. A disk storage device may be implemented as any type of magnetic or optical storage device, such as a hard disk drive, a recordable and/or rewriteable compact disc (CD), any type of a digital versatile disc (DVD), and the like.

The computer-readable medium 1114 provides data storage mechanisms to store the device data 1104, as well as various device applications 1118 and any other types of information and/or data related to operational aspects of the computing system 1100. For example, an operating system 1120 may be maintained as a computer application with the computer-readable medium 1114 and executed on the processor(s) 1110. The device applications 1118 may include a device manager, such as any form of a control application, a software application, signal-processing and control modules, code that is native to a particular device, an abstraction module, a gesture recognition module, and other modules. The device application(s) 1118 may also include system components, engines, or managers to implement articulated docking stations for mobile computing devices (e.g., the torque manager 212). The computing system 1100 may also include, or have access to, one or more machine learning systems. Other aspects of the subject matter described in this specification may be embodied in a computer-readable storage device storing instructions that, when executed by one or more processing devices, perform operations according to the above-described methods.

### Examples

In the following section, examples are provided.

Example 1. A method for controlling an articulation of a docking station, the method comprising: determining a hinge torque setting for supporting an angular position of the mobile computing device relative to the docking station; applying the hinge torque setting to a hinge assembly of the docking station to support the angular position of the mobile computing device relative to the docking station; receiving position sensor data from a position sensor; determining, utilizing the position sensor data, a user-induced motion to change the angular position of the mobile computing device to a new angular position; changing the hinge torque setting to permit the change in the angular position of the mobile computing device to the new angular position; receiving updated position sensor data from the position sensor; determining, utilizing the updated position sensor data, a cessation of the userinduced motion; and changing the hinge torque setting to support the new angular position of the mobile computing device relative to the docking station.

Example 2. The method of Example 1, wherein determining the hinge torque setting for supporting the angular position of the mobile computing device relative to the docking station further comprises: determining a hinge torque profile for the mounted mobile computing device, the hinge torque profile including a nominal current value for applying to a magneto-rheological (MR) brake of the docking station to generate a magnetic field that maintains an angular position of the mounted device relative to the docking station.

Example 3. The method of Example 1 or Example 2, wherein changing, responsive to determining the user-induced motion, the hinge torque setting to permit the change in the angular position of the mounted mobile computing device comprises: decreasing a current value applied to the MR brake to a level below the nominal current value to decrease a damping force of the MR brake.

Example 4. The method of any preceding Example, wherein changing the hinge torque setting to support the new angular position of the mobile computing device relative to the docking station further comprises: increasing the current value applied to the MR brake at an increased level above the decreased current value to increase the damping force of the MR brake and maintain the new angular position of the mounted device.

Example 5. The method of any preceding Example, further comprising: determining a direction of the user-induced motion of the hinge assembly to change the angular position of the mounted device, and wherein decreasing the current value applied to the MR brake to a level below the nominal current value to decrease the damping force of the MR brake is performed for user-induced motion in the determined direction.

Example 6. The method of any preceding Example, wherein determining a hinge torque profile for the mobile computing device comprises at least one of: receiving a device identifier from the mobile computing device and looking up the device identifier in a lookup table to determine the hinge torque profile; determining a device identifier for the mobile computing device and looking up the device identifier in a lookup table to determine the hinge torque profile; receiving the hinge torque profile from the mobile computing device; receiving user input and determining the hinge torque profile based on the user input; or applying a default hinge torque profile.

Example 7. The method of any preceding Example, further comprising: determining an unmounting of the mobile computing device from the docking station; and responsive to determining the unmounting, decreasing the current value applied to the MR brake to a level below the nominal current value to decrease the damping force of the MR brake.

Example 8. The method of any preceding Example, further comprising determining a mounting of a mobile computing device to the docking station, wherein determining the mounting of the mobile computing device to the docking station further comprises at least one of: utilizing a sensor to determine a presence of the mobile computing device at the docking station; determining that the mobile computing device has physically connected with the docking station; determining that the mobile computing device has wirelessly connected with the docking station; or receiving a wireless communication from the mobile computing device.

Example 9. The method of any preceding Example, further comprising: storing the determined hinge torque profile for the mobile computing device.

Example 10. The method of any preceding Example, further comprising: determining, utilizing the position sensor, a used angular position of the mounted device; storing the used angular position; and momentarily increasing the current value applied to the MR brake when the user-induced motion reaches the used angular position to provide feedback to a user of the stored used angular position.

Example 11. The method of any preceding Example, further comprising: receiving user input to lock the angular position of the mounted device; and responsive to receiving the user input to lock the angular position of the mounted device, increasing the current value applied to the MR brake to lock the angular position of the mounted device to a value greater than the nominal current value.

Example 12. The method of any preceding Example, further comprising: momentarily increasing and then decreasing the current value applied to the MR brake as a user changes the angular position of the mounted device to provide feedback to the user that mimics a detent.

Example 13. The method of any preceding Example, further comprising: determining a current angular position of the mounted device; and increasing or decreasing the current value applied to the MR brake to maintain the current angular position of the mounted device.

Example 14. A mobile computing device docking station comprising: a magneto-rheological (MR) brake including a magnetic field source and reservoir including MR fluid; a position sensor; a processor; and a memory having instructions stored thereon that, responsive to execution by the processor, cause the mobile computing device docking station to execute the method of any of Examples 1 to 13.

Example 15. An apparatus comprising: a processor; and a computer-readable storage medium (CRM) having stored thereon instructions that, responsive to execution by the processor, cause the processor to perform the method according to any of Examples 1 to 13.

### Conclusion

Throughout this disclosure, examples are described where a computing system (e.g., a docking station) may analyze information (e.g., determine device identifier information for a mobile computing device mounted on the docking station). Further to the descriptions above, a user may be provided with controls allowing the user to make an election as to both if and when systems, programs, and/or features described herein may enable collection of information (e.g., device identifier information) and if the user is sent content or communications from a server. The computing system can be configured to only use the information after the computing system receives explicit permission from the user of the computing system to use the data. For example, in situations where the docking station analyzes a mounted mobile computing device to determine device identifier information for the device in order to implement docking station articulation, individual users may be provided with an opportunity to provide input to control whether programs or features of the docking station can collect and make use of the device identifier information. Further, individual users may have constant control over what programs can or cannot do with the information. In addition, information collected may be pre-treated in one or more ways before it is transferred, stored, or otherwise used, so that personally identifiable information is removed. For example, before the docking station shares data (e.g., sensor data, device identifier information) with another device (e.g., to train a model executing at another device), the docking station may pre-treat the data to ensure that any user-identifying information or device-identifying information embedded in the data is removed. Thus, the user may have control over whether information is collected about the user and the user's device, as well as how such information, if collected, may be used by the computing system and/or a remote computing system.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

Although implementations of techniques and apparatuses directed at docking station articulation have been described in language specific to features and/or methods, it is to be understood that the subject of the appended claims is not necessarily limited to the specific features or methods described. Rather, the specific features and methods are disclosed as example implementations of techniques and apparatuses directed at docking station articulation.

1. A method for controlling an articulation of a docking station, the method comprising:
determining a hinge torque setting for supporting an angular position of a mobile computing device mounted in the docking station relative to the docking station;
applying the hinge torque setting to a hinge assembly of the docking station to support the angular position of the mobile computing device relative to the docking station;
receiving position sensor data from a position sensor;
determining, utilizing the position sensor data, a user-induced motion to change the angular position of the mobile computing device to a new angular position;
changing the hinge torque setting to permit the change in the angular position of the mobile computing device to the new angular position;
receiving updated position sensor data from the position sensor;
determining, utilizing the updated position sensor data, a cessation of the user-induced motion; and
changing the hinge torque setting to support the new angular position of the mobile computing device relative to the docking station.

2. The method of claim 1, wherein determining the hinge torque setting for supporting the angular position of the mobile computing device relative to the docking station further comprises:
determining a hinge torque profile for the mounted mobile computing device, the hinge torque profile including a nominal current value for applying to a magneto-rheological (MR) brake of the docking station to generate a magnetic field that maintains an angular position of the mounted mobile computing device relative to the docking station.

3. The method of claim 1, wherein changing, responsive to determining the user-induced motion, the hinge torque setting to permit the change in the angular position of the mounted mobile computing device comprises:
decreasing a current value applied to a magneto-rheological (MR) brake of the docking station to a level below the nominal current value to decrease a damping force of the MR brake.

4. The method of claim 3, wherein changing the hinge torque setting to support the new angular position of the mobile computing device relative to the docking station further comprises:
increasing the current value applied to the MR brake of the docking station at an increased level above the decreased current value to increase the damping force of the MR brake and maintain the new angular position of the mounted mobile computing device.

5. The method of claim 1, further comprising:
determining a direction of the user-induced motion of the hinge assembly to change the angular position of the mounted mobile computing device.

6. The method of claim 1, wherein determining a hinge torque profile for the mobile computing device comprises at least one of:
receiving a device identifier from the mobile computing device and looking up the device identifier in a lookup table to determine the hinge torque profile;
determining a device identifier for the mobile computing device and looking up the device identifier in a lookup table to determine the hinge torque profile;
receiving the hinge torque profile from the mobile computing device;
receiving user input and determining the hinge torque profile based on the user input; or
applying a default hinge torque profile.

7. The method of claim 1, further comprising:
determining an unmounting of the mobile computing device from the docking station; and
responsive to determining the unmounting, decreasing a current value applied to a magneto-rheological (MR) brake of the docking station to a level below the nominal current value to decrease a damping force of the MR brake.

8. The method of claim 1, further comprising, determining a mounting of a mobile computing device to the docking station, wherein determining the mounting of the mobile computing device to the docking station further comprises at least one of:
utilizing a sensor to determine a presence of the mobile computing device at the docking station;
determining that the mobile computing device has physically connected with the docking station;
determining that the mobile computing device has wirelessly connected with the docking station; or
receiving a wireless communication from the mobile computing device.

9. The method of claim 2, further comprising:
storing the determined hinge torque profile for the mobile computing device.

10. The method of claim 1, further comprising:
determining, utilizing the position sensor, a used angular position of the mounted mobile computing device;
storing the used angular position; and
momentarily increasing a current value applied to a magneto-rheological (MR) brake of the docking station when the user-induced motion reaches the used angular position to provide feedback to a user of the stored used angular position.

11. The method of claim 1, further comprising:
receiving user input to lock the angular position of the mounted mobile computing device; and
responsive to receiving the user input to lock the angular position of the mounted mobile computing device, increasing a current value applied to a magneto-rheological (MR) brake of the docking station to lock the angular position of the mounted mobile computing device to a value greater than the nominal current value.

12. The method of claim 1, further comprising:
momentarily increasing and then decreasing a current value applied to a magneto-rheological (MR) brake of the docking station as a user changes the angular position of the mounted mobile computing device to provide feedback to a user that mimics a detent.

13. The method of claim 1, further comprising:
determining a current angular position of the mounted mobile computing device; and
increasing a current value applied to a magneto-rheological (MR) brake of the docking station to maintain the current angular position of the mounted mobile computing device.

14. (canceled)

15. (canceled)

16. The method of claim 1, further comprising:
determining a current angular position of the mounted mobile computing device; and
decreasing a current value applied to a magneto-rheological (MR) brake of the docking station to maintain the current angular position of the mounted mobile computing device.

17. The method of claim 1, wherein determining the hinge torque setting for supporting the angular position of the mobile computing device relative to the docking station further comprises:
determining a hinge torque profile for the mounted mobile computing device, the hinge torque profile including a nominal current value for applying to a magneto-rheological (MR) brake of the docking station to generate a magnetic field that maintains an angular position of the mounted mobile computing device relative to the docking station;
determining, utilizing the position sensor, a used angular position of the mounted mobile computing device;
storing the used angular position; and
momentarily increasing the current value applied to the MR brake of the docking station when the user-induced motion reaches the used angular position to provide feedback to a user of the stored used angular position.

18. The method of claim 1,
wherein determining the hinge torque setting for supporting the angular position of the mounted mobile computing device relative to the docking station further comprises determining a hinge torque profile for the mounted mobile computing device, the hinge torque profile including a nominal current value for applying to a magneto-rheological (MR) brake of the docking station to generate a magnetic field that maintains an angular position of the mounted mobile computing device relative to the docking station, and
wherein the method further comprises momentarily increasing and then decreasing the current value applied to the MR brake of the docking station as a user changes the angular position of the mounted mobile computing device to provide feedback to a user that mimics a detent.

19. The method of claim 1, wherein the position sensor is a position sensor of the docking station.

20. The method of claim 5, wherein decreasing a current value applied to a magneto-rheological (MR) brake of the docking station to a level below the nominal current value to decrease a damping force of the MR brake is performed for user-induced motion in the determined direction.

21. A mobile computing device docking station comprising:
a magneto-rheological (MR) brake including a magnetic field source and reservoir including MR fluid;
a position sensor;
a processor; and
a memory having instructions stored thereon that, responsive to execution by the processor, cause the mobile computing device docking station to:
determine a hinge torque setting for supporting an angular position of a mobile computing device relative to the docking station;
apply the hinge torque setting to a hinge assembly of the docking station to support the angular position of the mobile computing device relative to the docking station;
receive position sensor data from a position sensor;
determine, utilizing the position sensor data, a user-induced motion to change the angular position of the mobile computing device to a new angular position;
change the hinge torque setting to permit the change in the angular position of the mobile computing device to the new angular position;
receive updated position sensor data from the position sensor;
determine, utilizing the updated position sensor data, a cessation of the user-induced motion; and
change the hinge torque setting to support the new angular position of the mobile computing device relative to the docking station.

22. An apparatus comprising:
a processor; and
a computer-readable storage medium (CRM) having stored thereon instructions that, responsive to execution by the processor, cause the processor to:
determine a hinge torque setting for supporting an angular position of a mobile computing device relative to a docking station;
apply the hinge torque setting to a hinge assembly of the docking station to support the angular position of the mobile computing device relative to the docking station;
receive position sensor data from a position sensor;
determine, utilizing the position sensor data, a user-induced motion to change the angular position of the mobile computing device to a new angular position;
change the hinge torque setting to permit the change in the angular position of the mobile computing device to the new angular position;
receive updated position sensor data from the position sensor;
determine, utilizing the updated position sensor data, a cessation of the user-induced motion; and
change the hinge torque setting to support the new angular position of the mobile computing device relative to the docking station.
